(19) United States
(12) Patent Application Publication
(10) Pub. No.: US 2025/0376419 A1
(43) Pub. Date: Dec. 11, 2025

(54) GREEN CALCIUM SILICATE HYDRATE BOARDS AND PROCESS THEREO

(71) Applicants: PRTC NV, Tisselt (BE); ETEX BUILDING PERFORMANCE NV, Tisselt (BE)

(72) Inventors: Xiao WU, Sint Stevens Woluwe (BE); Bert BERGE, Sint Katelijne Waver (BE)

(21) Appl. No.: 18/876,822

(22) PCT Filed: Jun. 28, 2023
(86) PCT No.: PCT/EP2023/067654

§ 371 Date: Dec. 19, 2024

(30) Foreign Application Priority Data
Jun. 29, 2022 (EP) 22181876.8

(51) Int. Cl. C04B 28/10; B28B 11/24; C04B 14/04; C04B 18/167; C04B 18/24; C04B 20/04; C04B 40/00; C04B 111/00

(52) U.S. Cl. CPC C04B 28/10; C04B 14/043; C04B 18/167; C04B 18/24; C04B 20/04; C04B 40/0071; C04B 40/0082; B28B 11/24; C04B 2111/00612; C04B 2201/20

(57) ABSTRACT

A composition and process for making calcium silicate hydrate board, which comprises preparing a slurry of a mixture of silicic material, lime material, spherical xonotlite particles, synthetic wollastonite and reinforcing fibres with balanced water; forming the slurry into a board by means of the sheet-forming technologies; steam curing the board and drying.

### TECHNICAL FIELD

The invention is related a calcium silicate hydrate composition of boards for building application, fire protection and thermal insulation, to a method for producing such calcium silicate hydrate material and the use of calcium silicate hydrate boards comprising synthetic wollastonite.

### BACKGROUND OF THE INVENTION

Calcium silicate hydrate board, commonly named calcium silicate boards, as disclosed by GB 2,085,044 comprising calcium silicate binder; spherical xonotlite particles; natural acicular wollastonite and reinforcing fibres, have very good mechanical properties and durability in service life, while keep good thermal stability at high temperatures (such as at 1000° C.).

The board is traditionally produced by mixing the calcareous and siliceous raw materials, spherical xonotlite particles made beforehand, natural acicular or needle like wollastonite, reinforcing fibers and balanced water to form a slurry. Shaping can be made by conventional process, such as Filter Pres process.

For Filter Press molding, it generally comprises a perforated molding surface over which the slurry is poured. A perforated mechanical piston, complementary in shape to the mold, compresses and slurry and dewaters it to the point where it is self-supporting. The filter press molding technique is conducted in the absence of any applied heat and under pressure sufficient only to express out water from the slurry in the filter press and to form solid articles such as pipe covering and flat board. The filter press molding technique is described in U.S. Pat. No. 4,477,397.

The shaped body is further cured in hydrothermal condition, to react the siliceous material and lime material, and possibly, to react these materials with the surface of xonotlite spherical particles, thereby producing a matrix comprising tobermorite and/or xonotlite as binder. The steam curing is conducted in an autoclave under a vapor pressure of 6-18 kg/cm² for a sufficient time until the siliceous and lime material transfer to tobermorite and/or xonotlite.

After the hydrothermal curing, the calcium silicate hydrate board is removed from the autoclave, and dried, if required. The drying temperature must be below the decomposition point of the organic fibre to obtain the required properties.

Once dried, the final board is cut and could be sanded to form required dimension. This generates somewhat production wastes, i.e., cutting waste and sanding dust. A part of them can be directly recycled in the production process. However, the quantity is limited in order to keep the material performance within the product specification.

Natural acicular or needle like wollastonite, such as Nyad-G sold by Imerys, is a key ingredient. It does indeed increase strength, maintains high temperature stability and also helps to prevent cracking and improves machinability.

However, since pandemic crisis, supply of the natural acicular wollastonite becomes a problem, the mine exploration is disrupted, the shipping cost is skyrocketed due to lockdown. Without this needle like wollastonite, manufacturing of these products has to be reduced or stopped.

### SUMMARY OF THE INVENTION

Therefore, it is an objective of the current invention to find an alternative to the natural acicular wollastonite, to safe guide the production.

Another objective is to recover wollastonite, a strategic raw material for calcium silicate composition, from calcium silicate hydrate waste, preferably the own calcium silicate waste.

Another objective is to reuse all calcium silicate hydrate production waste and to stop landfilling, to improve industrial applicability of the technology and help the circular economy.

The present invention is defined in the appended independent claims. Preferred embodiments are defined in the dependent claims. In particular, the present invention concerns a composition for manufacturing a calcium silicate hydrate board comprising:
i. Calcareous and siliceous material having a CaO/SiO2, mole ration of 0.6-1.2,
ii. Spherical xonotlite particles obtained by hydrothermal synthesis
iii. Wollastonite,
iv. Reinforcing fibres such as cellulose and/or organic and/or inorganic fibres,
v. Balanced water,
wherein the wollastonite is synthetic and is made by calcination of calcium silicate hydrate waste.

In a preferred embodiment, the synthetic wollastonite is obtained by calcined waste of calcium silicate hydrate boards produced using the composition comprising the components i to v of the composition board. The objective is indeed to increase the use of the waste of the calcium silicate hydrate board and reuse in own production.

The synthetic wollastonite is obtained by calcining calcium silicate hydrate production waste at a temperature below 1000° C. wherein the production waste comprises xonotlite spherical particles having an internal part in which the crystals of xonotlite are loosely entangled and distributed rather uniformly and an external layer in which the crystals are entangled more tightly than in the internal part.

In a preferred embodiment, the composition further comprises recycled calcium silicate hydrate waste. This recycled calcium silicate hydrate waste is not calcined. More precisely, the composition comprises
i. 20-50 parts by weight of a mixture of calcareous and siliceous material having a CaO/SiO2, mole ratio of 0.6-1.2,
ii. 10-40 parts by weight of spherical xonotlite particles obtained by hydrothermal synthesis,
iii. 5-50 parts by weight of synthetic wollastonite obtained by calcination of calcium silicate hydrate waste,
iv. 2-10 parts by weight of reinforcing fibres such as cellulose and/or organic and or inorganic fibres,
v. Balanced calcium silicate hydrate production waste,
vi. Balanced water.

In a preferred embodiment, the synthetic wollastonite has a particle size below or equal to ca 2 mm.

The calcium silicate hydrate waste used to produce the synthetic wollastonite may contain tobermorite, preferably less than 50% wt related, more preferably less than 20 wt. % and even more preferably less than 5 wt. % to the total weight of the calcium silicate hydrate waste.

The present invention also concerns a process for manufacturing a calcium silicate hydrate board comprising the following steps,
i. Provide synthetic wollastonite obtained by calcination of calcium silicate hydrate waste at a temperature below 1000° C.,
ii. Prepare a slurry made by stirring lime and siliceous material having a CaO/SiO2, mole ratio of 0.6-1.2 and comprising spherical xonotlite particles obtained by hydrothermal synthesis, synthetic wollastonite, reinforcing fibres and water,
iii. Mold the slurry,
iv. Cure said molded body in a hydrothermal condition at 160-210° C. and a pressure at 6-18 bar to form tobermorite and/or xonotlite binder and
v. Dry said cured body to remove water therefrom.

The drying step removes the free water and not the crystallize one.

The calcium silicate hydrate waste comprises less than 50% of xonotlite spherical particles having an internal part in which the crystals of xonotlite are loosely entangled and distributed rather uniformly and an external layer in which the crystals are entangled more tightly than in the internal part.

The calcium silicate hydrate waste may contain tobermorite.

The molding may be made by Hatcheck process, Magnani process and Filter Press process.

The spherical xonotlite particles is made by hydrothermal synthesis in a stirred medium, using an aqueous lime and silica suspension, the lime suspension being obtained by hydration in the presence of 0.2 to 2% by weight of sulphate with respect to the weight of lime, as disclosed by the WO2020152335.

The synthetic wollastonite is made by batch or not calcination or by flash calcination at below 1000° C. and preferably around 850° C.

Calcium silicate hydrate boards can be further heat treated at high temperature of below 1000° C.

The present invention also concerns the use of calcium silicate hydrate board obtained by a process as described here above, for building application, fire protection and high temperature insulation.

The calcium silicate hydrate boards have a dry density around 250 to 1000 kg/m³, more preferably 400 to 900 kg/m³. The dry density is measured according to the norm EN12467.

### BRIEF DESCRIPTION OF THE FIGS.

FIG. 1 shows a picture of spherical xonotlite particles used as component of the composition.

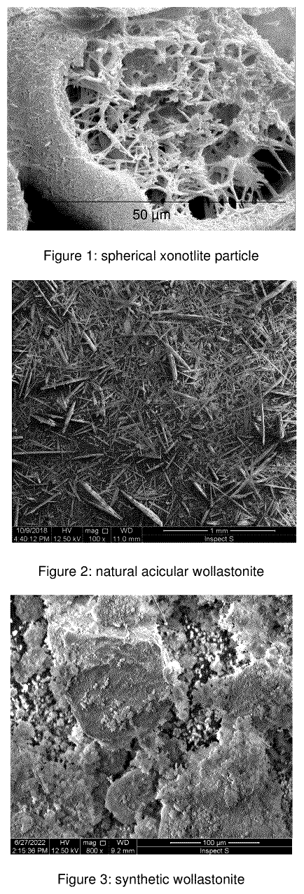

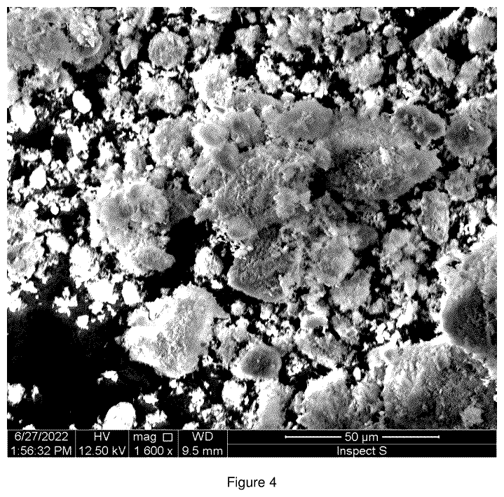

FIG. 2 shows a picture of acicular wollastonite.

FIGS. 3 & 4 show a picture of synthetic wollastonite according to the present invention.

### DETAIL DESCRIPTION OF THE INVENTION

The present invention concerns a composition for manufacturing a calcium silicate hydrate material comprising:
Calcareous and siliceous material having a CaO/SiO2, mole ratio of 0.6-1.2,
Spherical xonotlite particles obtained by hydrothermal synthesis.
Synthetic wollastonite, made by calcination of calcium silicate hydrate waste,
Reinforcing fibres, organic fibres such as cellulose and/or inorganic fibres,
Balanced amount of water.

Although the process of transforming tobermorite and xonotlite into wollastonite is known—as described by U.S. Pat. No. 3,967,974—the synthetic wollastonite of this invention is different, the synthetic wollastonite is not composed of individual crystals, but rather acicular crystals agglomerated in spherical shape because of the morphology of initial spherical xonotlite particles. It includes also broken fraction due to the sanding process. It was surprisingly found that the synthetic wollastonite of current invention can be used to replace the natural needle like wollastonite in the composition, without any negative effect on the mechanical strength and thermal stability at high temperatures for the final product. It is believed that good affinity between the spherical xonotlite and the synthetic wollastonite agglomerates contributes to the excellent performance.

In accordance with this invention, the synthetic wollastonite is made by calcination at below 1000° C., and preferably around 850° C., when tobermorite and xonotlite transfer to beta wollastonite, as it is confirmed by X-ray diffraction analysis. The temperature higher than 1000° C. can be used but has no advantages. Traditional calcination technology can be used, a flash calcination is preferred.

In accordance with this invention, the synthetic wollastonite is obtained by calcining preferably own calcium silicate hydrate production waste at a temperature below 1000° C., wherein the waste comprises spherical xonotlite particles having an internal part in which the crystals of xonotlite are loosely entangled and distributed rather uniformly and an external layer in which the crystals are entangled more tightly than in the internal part.

The composition may comprise recycled calcium silicate hydrate material. The recycled calcium silicate hydrate material is not calcined. However, the amount of recycled calcium silicate hydrate should not be higher than 30 wt. % of the total dry weight of the composition in order to not impair the thermal shrinkage of the board.

The preferred particle size of synthetic wollastonite of this invention is below or equal to ca 2 mm.

A typical composition of the present invention comprises
20-50 parts by weight of a mixture of calcareous and siliceous material having a CaO/SiO2, mole ratio of 0.6-1.2,
10-40 parts by weight of spherical xonotlite particles obtained by hydrothermal synthesis,
5-50 parts by weight of synthetic wollastonite obtained by calcination of calcium silicate hydrate waste,
2-10 parts by weight of reinforcing organic fibres such as cellulose and/or inorganic fibres, balanced calcium silicate hydrate production waste and balanced water.

The percentage of synthetic wollastonite used in this invention is between 5 and 50%, preferably between 10 and 35 wt. % relative to the total dry weight of the composition. In this dosage, all of the calcium silicate hydrate production waste can be reused, either as the synthetic wollastonite, or the recycled waste directly used in the production. This reduces production cost, stops land filling, and helps the circular economy.

The balanced water is an amount of 5-25 times as much as that of the total dry weight of the composition.

In accordance with this invention, next to the synthetic wollastonite, spherical xonotlite particles obtained by hydrothermal synthesis plays an important role. These particles surrounded by the binder indeed represent the main volume once the board is made.

These agglomerated spherical particles as shown in FIG. 1, impact the morphology of the synthetic wollastonite agglomerates after calcination.

In order to produce the spherical xonotlite particles, an aqueous lime and silica suspension is reacted in hydrothermal condition in a stirred medium, wherein the lime suspension is obtained by hydration in the presence of 0.2 to 2% by weight of sulfate with respect to the weight of lime as described in WO2020152335 or in WO 99/46215. The resulted spherical xonotlite particles have an internal part in which the crystals are loosely entangled and distributed rather uniformly and an external layer in which the crystals are entangled more tightly than in the internal part. The said crystal aggregates advantageously have a mean diameter of between 20 and 150 microns, preferably between 40 and 80 microns, and the outer layer advantageously has a thickness of between 4 and 10 microns, preferably between 4 and 6 microns.

This invention also relates to a process for manufacturing a calcium silicate hydrate board comprising the following steps.
Provide synthetic wollastonite obtained by calcination of calcium silicate hydrate waste at a temperature below 1000° C.,.
Prepare a slurry made by stirring lime and siliceous material having a CaO/SiO2, mole ratio of 0.6-1.2 and comprising spherical xonotlite particles obtained by hydrothermal synthesis; synthetic wollastonite; reinforcing fibres and water.
mold the slurry,.
cure said molded body in a hydrothermal condition at 160-210° C. and a pressure at 6-18 bar to form tobermorite and/or xonotlite binder, and.
dry said cured body to remove water therefrom.

The calcium silicate waste comprises spherical xonotlite particles having an internal part in which the crystals of xonotlite are loosely entangled and distributed rather uniformly and an external layer in which the crystals are entangled more tightly than in the internal part.

The calcium silicate hydrate waste may comprise tobermorite.

The slurry is made of 20-50 parts by weight of a mixture of calcareous and siliceous material having a CaO/SiO2, mole ratio of 0.6-1.2,10-40 parts by weight of spherical xonotlite particles obtained by hydrothermal synthesis, 5-50 parts by weight of synthetic wollastonite obtained by calcination of calcium silicate hydrate waste, 2-10 parts by weight of reinforcing organic fibres such as cellulose and/or inorganic fibres.

In particular the slurry may comprise 5-35 parts or 5-25 parts or 5-15 parts by weight of synthetic wollastonite obtained by calcination of calcium silicate hydrate waste.

The slurry may further comprise a balanced amount of recycled waste and in particular calcium silicate hydrate waste up to 30 wt % of the total dry weight of the composition.

The molding may be done by Hatcheck process, Magnani process, or Filter Press process.

The calcium silicate hydrate board in accordance with this invention can be further heat treated at high temperatures, such as below 1000° C., when required.

The calcium silicate hydrate board in accordance with this invention has dry density at around 250-1000 kg/m³, more preferably between 400 to 900 kg/m³.

### EXAMPLES

Calcium silicate hydrate boards are produced according to the following procedure: all dry components shown in the Tab. 1 and balanced amount of water are homogeneously mixed. Forming is by filter press. The molded body is autoclaved at 160-200° C. and at 7-12 Bar for 10 hrs, then oven dried at 105° C.

FIG. 1 shows a Scanning Electron Microscope (SEM) picture of a spherical xonotlite particle used in the examples. FIG. 2 shows a SEM picture of natural wollastonite. FIG. 3 shows synthetic wollastonite of this invention.

The final products were then tested according to EN-norms. The bending strength was measured according to EN 12467:2012. The thermal shrinkage as well as the Loss Of Ignition (LOI %) was determined at 1000° C. according to EN 1094-6:2000.

Table 2 shows the results. They evidently demonstrate the synthetic wollastonite of this invention can replace natural acicular wollastonite without negative influence on the mechanical strength and high temperature stability.

TABLE 1

| | | | | | Cellu- | |
|---|---|---|---|---|---|---|
| | | Quartz | Spherical | | lose | Total |
| wt % | Ca(OH)2 | sand | Xonotlite | Wollastonite | fibre | by wt |
| Ref. 1 | 23.8 | 17.4 | 25.5 | 30.0 | 3.3 | 100.0 |
| | | | | natural | | |
| | | | | acicular | | |
| Exam- | 23.8 | 17.4 | 25.5 | 30.0 | 3.3 | 100.0 |
| ple 1 | | | | Synthetic | | |
| | | | | (invention) | | |
| Ref. 2 | 28.2 | 20.3 | 32.5 | 15.0 | 4.0 | 100.0 |
| | | | | natural | | |
| | | | | acicular | | |
| Exam- | 28.2 | 20.3 | 32.5 | 15.0 | 4.0 | 100.0 |
| ple 2 | | | | Synthetic | | |
| | | | | (invention) | | |

TABLE 2

| | | | | Thermal shrinkage at | | | | |
|---|---|---|---|---|---|---|---|---|
| | | | bending | 1000° C. for 4 hrs | | | | |
| | Wollastonite | Density | strength | LOI | l, | w, | t, | aver- |
| | (wt. %) | g/cm³ | Mpa | % | % | % | % | age |
| Ref 1 | commercial | 0.637 | 3.9 | 11.2 | 0.8 | 0.8 | 1.9 | 1.2 |
| | wollastonite | | | | | | | |
| | (30) | | | | | | | |
| Exam- | synthetic | 0.640 | 3.8 | 11.5 | 1.2 | 1.0 | 2.1 | 1.4 |
| ple 1 | wollastonite | | | | | | | |
| | (30) | | | | | | | |
| Ref 2 | Commercial | 0.640 | 6.0 | 11.0 | 0.7 | 0.8 | 1.8 | 1.1 |
| | wollastonite | | | | | | | |
| | (15) | | | | | | | |
| Exam- | synthetic | 0.636 | 6.2 | 10.8 | 1.0 | 1.0 | 1.3 | 1.1 |
| ple 2 | wollastonite | | | | | | | |
| | (15) | | | | | | | |

Besides maintaining mechanical properties, acoustic properties were also maintained if not improved.

5

1. A composition for manufacturing a calcium silicate hydrate board comprising:
i) calcareous and siliceous material having a CaO/SiO2, mole ratio of 0.6-1.2,
ii) spherical xonotlite particles obtained by hydrothermal synthesis,
iii) wollastonite,
iv) reinforcing fibres such cellulose and/or organic and/or inorganic fibres,
v) balanced water, characterised in that the wollastonite is synthetic and is obtained by calcination of calcium silicate hydrate waste.

2. The composition according to claim 1. wherein the synthetic wollastonite is obtained by calcining waste of calcium silicate hydrate board made using the composition comprising the components i to v according to claim 1.

3. The composition according to claim 1, wherein the synthetic wollastonite is obtained by calcination of calcium silicate waste at a temperature below 1000° C., said calcium silicate hydrate waste comprises xonotlite spherical particle having an internal part in which the crystals of xonotlite are loosely entangled and distributed rather uniformly and an external layer in which the crystals are entangled more tightly than in the internal part.

4. The composition according to claim 1, wherein the composition further comprises recycled calcium silicate hydrate waste, said recycled calcium silicate hydrate waste being not calcined.

5. The composition according to claim 1, wherein the composition comprises
i. 20-50 parts by weight of a mixture of calcareous and siliceous material having a CaO/SiO2, mole ratio of 0.6-1.2
ii. 10-40 parts by weight of spherical xonotlite particles obtained by hydrothermal synthesis,
iii. 5-50 parts by weight of synthetic wollastonite obtained by calcination of calcium silicate hydrate waste,
iv. 2-10 parts by weight of reinforcing fibres such as cellulose and/or organic and or inorganic fibres,
v. balanced calcium silicate production waste,
vi. balanced water.

6. The composition according to claim 1, wherein the synthetic wollastonite has a particle size below or equal to ca 2 mm.

7. The composition according to claim 1, wherein the calcium silicate hydrate waste used to produce synthetic wollastonite comprises tobermorite.

8. A Process for manufacturing a calcium silicate hydrate board comprising the following steps
i. Provide provide synthetic wollastonite obtained by calcination of calcium silicate hydrate waste at a temperature below 1000° C.,
ii. Prepare prepare a slurry made by stirring lime and siliceous material having a CaO/SiO2, mole ratio of 0.6-1.2 and comprising spherical xonotlite particles obtained by hydrothermal synthesis; synthetic wollastonite; reinforcing fibres and water,
iii. mold the slurry,
iv. cure said molded body in a hydrothermal condition at 160-210° C. and a pressure at 6-18 bar to form tobermorite and/or xonotlite binder and
v. dry said cured body remove water therefrom.

9. The process according to claim 8, wherein molding can be made by Hatcheck process, Magnani process or Filter Press process.

10. The process according to claim 8, wherein spherical xonotlite particles is made by hydrothermal synthesis in a stirred medium, using an aqueous lime and silica suspension, the lime suspension being obtained by hydration in the presence of 0.2 to 2% by weight of sulphate with respect to the weight of lime.

11. The process according to claim 8, wherein the calcium silicate hydrate waste comprises xonotlite spherical particles having an internal part in which the crystals of xonotlite are loosely entangled and distributed rather uniformly and an external layer in which the crystals are entangled more tightly than in the internal part.

12. The process according claim 8, wherein the synthetic wollastonite is made by calcination and/or flash calcination.

13. Calcium silicate hydrate board obtained by the process according to claim 8, wherein the calcium silicate hydrate board can be further heat treated at high temperature of below 1000° C.

14. Calcium silicate hydrate board according to claim 13, wherein the board has dry density at around 250-1000 kg/m³.

15. (canceled)

16. The composition according to claim 2, wherein the synthetic wollastonite is obtained by calcination of calcium silicate waste at a temperature below 1000° C., said calcium silicate hydrate waste comprises xonotlite spherical particle having an internal part in which the crystals of xonotlite are loosely entangled and distributed rather uniformly and an external layer in which the crystals are entangled more tightly than in the internal part.

17. The composition according to claim 2, wherein the composition further comprises recycled calcium silicate hydrate waste, said recycled calcium silicate hydrate waste being not calcined.

18. The composition according to claim 2, wherein the composition comprises
i. 20-50 parts by weight of a mixture of calcareous and siliceous material having a CaO/SiO2, mole ratio of 0.6-1.2
ii. 10-40 parts by weight of spherical xonotlite particles obtained by hydrothermal synthesis,
iii. 5-50 parts by weight of synthetic wollastonite obtained by calcination of calcium silicate hydrate waste,
iv. 2-10 parts by weight of reinforcing fibres such as cellulose and/or organic and or inorganic fibres,
v. balanced calcium silicate production waste,
vi. balanced water.

19. The composition according to claim 2, wherein the synthetic wollastonite has a particle size below or equal to ca 2 mm.

20. The composition according to claim 2, wherein the calcium silicate hydrate waste used to produce synthetic wollastonite comprises tobermorite.

21. Calcium silicate hydrate board according to claim 13, wherein the board has dry density between 400-900 kg/m³.
